(19) United States
(12) Patent Application Publication
(10) Pub. No.: US 2011/0133049 A1
(43) Pub. Date: Jun. 9, 2011

(54) Vibration control of an optical table by disturbance response decoupling

(75) Inventors: Fu-Cheng Wang, Taipei (TW); Min-Feng Hong, Kaohsiung City (TW)

(73) Assignee: National Taiwan University, Taipei (TW)

(21) Appl. No.: 12/801,520

(22) Filed: Jun. 14, 2010

(30) Foreign Application Priority Data
Dec. 4, 2009 (TW) 098141535

(51) Int. Cl. F16F 15/02; G05D 19/00; F16M 13/00; G01M 1/38

(52) U.S. Cl. 248/550; 700/280

(57) ABSTRACT

This invention discloses an optical table and the vibration control method thereof. Using disturbance response decomposing techniques, a double-layer structure is applied to independently control the ground and load disturbances. This invention can simplify the vibration control and improve system performance.

### BACKGROUND OF THE INVENTION

1. Field of the Invention

This invention relates to an optical table and a vibration control method thereof, particularly to a vibration control of an optical table by disturbance response decoupling.

2. Description of the Prior Art

With the prosperous growth of precision industries, the impacts of “vibration” on the quality of industrial products or manufacturing processes are increasing, which also receives general attention from all industrial sectors. There are two sources of common vibrations. The first is ground vibrations, which might be caused by the movement of laboratory personnel or the building. The second is load disturbances, such as machine vibrations or sound waves.

Basically, in order to overcome the vibration problems, the industrial sectors have various solutions, such as reinforcing building foundation, or applying optical tables to control vibrations.

There are two kinds of optical tables: the passive platforms and the active platforms. The passive optical tables employ spring and damper components to reduce the influence of environmental disturbances. In recent years, air suspensions are often used to isolate vibrations. The advantage of air suspensions is that the response is fast, and the parameters of springs and dampers can be adjusted by air pressure, air cushion springs and damper orifices in order to isolate ground disturbances. On the other hand, the active optical tables apply energy to drive actuators to improve system performance.

Conventionally, using passive optical tables usually can control the transmission of ground disturbances to the table, but it cannot effectively control load disturbances. And though the active optical tables can control the ground and load disturbances at the same time, the design of controllers will be very complicated due to the coupling effects, and the vibration control performance will be limited because of the influence of the aforementioned ground and load disturbances. For example, the system should be relatively “soft” to the ground vibrations, so that the table would not sense the vibrations. On the other hand, the system should be relatively “stiff” to the load disturbances, so that it can quickly dissipate the vibration energy. Thus, the vibration control of conventional optical tables is a compromise between the conflict performance requirements.

Therefore, in order to produce more efficient vibration control platforms, it is necessary to develop innovative technologies for vibration control platforms, in order to improve the control efficiency, and to reduce the design time and relevant cost of the vibration control platforms.

### SUMMARY OF THE INVENTION

The purpose of this invention is to provide an optical table thereof, in order to improve the existing vibration control platform apparatus and the vibration control performance.

The double-layer vibration control apparatus provided by this invention connects two layers of vibration control mechanism, wherein the upper layer vibration control mechanism is composed of passive vibration control components and an active actuator, and the lower layer vibration control mechanism is composed of passive vibration control components. The device also needs to measure the acceleration of the upper mass and the displacement between the upper mass and the middle mass. The disturbance response decoupling technique is employed to design the feedback control loop, in order to decouple the effects of ground vibrations and load vibrations. The ground vibrations are controlled by the passive components, and the active actuator is employed to improve the system responses to load disturbances.

This invention uses the disturbance response decoupling technique and the feedback control structure to independently control the ground and load disturbances. Thus the design and installation of the active controller can control the load disturbances without influencing the control ability of the ground disturbances.

This invention can be applied to any platform or carrier influenced by the external vibrations, such as the automobile industry, train industry, building industry, vibration resistance systems, precision machinery, optical vibration control platforms, and so on.

The technological characteristics of this invention are combining the double-layer vibration control structure and suitable feedback control through the disturbance response decoupling techniques, such that the actuator is only activated by the load disturbances without being influenced by the ground disturbances. Thus, it can use the active actuator to control the load disturbances, and use the passive components to control the ground disturbances.

The upper active control layer of this invention can be used to control the load disturbances. The control ability to the ground disturbances can also be improved through the concept of “negative springs”, which means to provide negative spring stiffness using the active actuator.

The upper active control layer of this invention uses the voice-coil motor as the actuator. The piezoelectric actuator can also be connected to a spring in serial, in order to control the load disturbances. The double-layer platform vibration control apparatus using the disturbance response decoupling provided by this invention not only can simplify the vibration control design, but also can improve the vibration control performance effectively.

Therefore, the advantage and spirit of the invention can be understood further by the following detail description of invention and attached Figures.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a graph illustrating the optical table for the embodiment of this invention.

FIG. 2 is a graph illustrating the optical table for another embodiment of this invention.

FIG. 3 is a graph illustrating the upper structure of the optical table for another embodiment of this invention.

FIG. 4 is a graph illustrating the whole optical table of this invention.

FIG. 5 is a graph illustrating the exploded mode for the whole optical table of this invention.

FIG. 6 is a graph illustrating the vibration control flowchart of this invention.

FIG. 7 is a graph illustrating the disturbance response decoupling result of this invention.

FIG. 8 is a graph illustrating the system responses of (T_{z}_{ᵣ}_{→z}_{ₛ})_{bounce}.

FIG. 9 is a graph illustrating the frequency responses of (T_{F}_{ₛ}_{→z}_{ₛ})_{bounce}.

FIG. 10 is a graph illustrating the time domain responses.

### DESCRIPTION OF THE PREFERRED EMBODIMENT

This invention relates to an optical table and the vibration control method thereof. The disturbance response decoupling technique is used to decouple the effects of ground disturbances and load disturbances and to improve the vibration control performance.

This invention relates to an optical table and the vibration control method thereof, which is described by the following embodiment and figures:

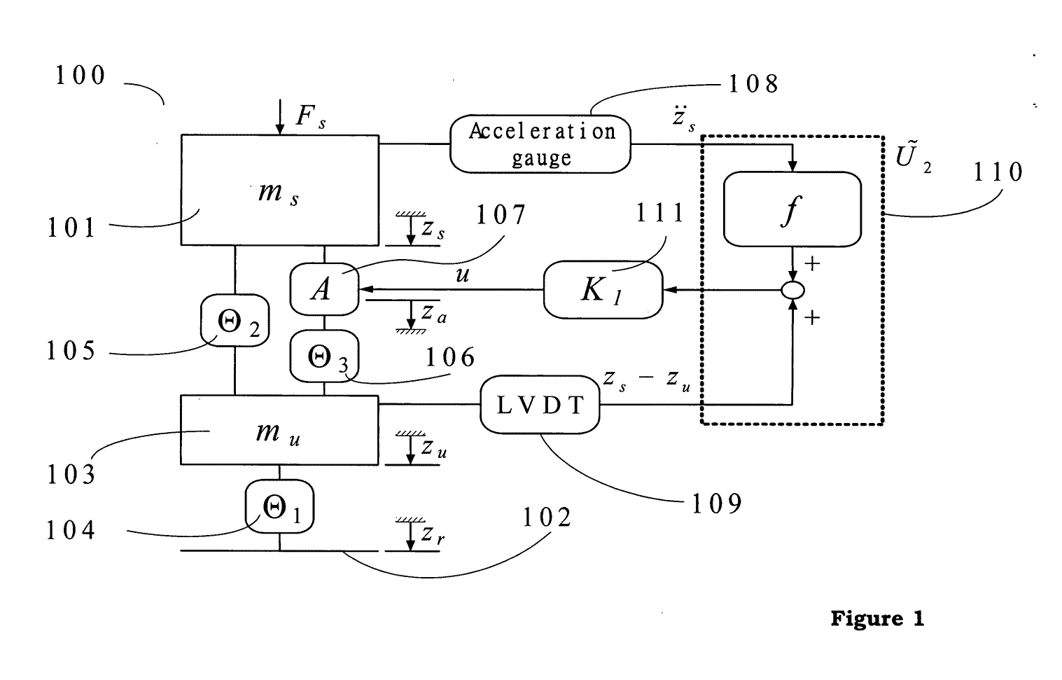

As shown in FIG. 1, the schematic diagram for the optical table of this invention is illustrated. The optical table 100 comprises an upper mass 101 (i.e., table board), lower floor terminal 102 (i.e., ground) and middle mass 103 (i.e., metal block). The vibration control mechanism comprises the first passive vibration control component 104 (any type of component, such as the commercial pneumatic vibration control mechanism), the second passive vibration control component 105 (any type of component, such as the damper), and the third passive vibration control component 106 (any type of component, such as the spring). The upper layer of optical table 100 comprises an active actuator 107 (such as the voice-coil motor, piezoelectric actuator etc.) for controlling the load disturbances. The sensor is composed of an acceleration gauge 108 and a linear variable differential transformer (LVDT) 109. The decoupling control loop structure 110 and the controller 111 can calculate the control signal to drive the active actuator 107. The optical table 100 provided by this invention can be used in any platform or carrier influenced by external vibrations, such as the automobile industry, train industry, building industry, vibration resistance systems, precision machinery, optical vibration control platforms, and so on.

As shown in FIG. 1, the acceleration signal \ddot{z}ₛ of acceleration gauge 108 and the relative displacement zₛ-zᵤ of linear differential transformer 109 are fed back to the control structure Ũ₂=[mₛ/Θ₂+Θ₃)1], which is derived by the disturbance response decoupling technique. It is to say after the feedback signal is calculated by the decoupling control loop structure 110, the control signal can only be activated by the load disturbance signal. The corresponding control signal is calculated by the controller 111, and it is output to the active actuator 107, in order to convert the electronic signal to equivalent physical quantity for suppressing load vibrations. In addition, by measuring the acceleration signal \ddot{z}ₛ and the displacement signal zₛ-zᵤ for controller design, the system can achieve any performance with full feedbacks (i.e. to measure all possible signals).

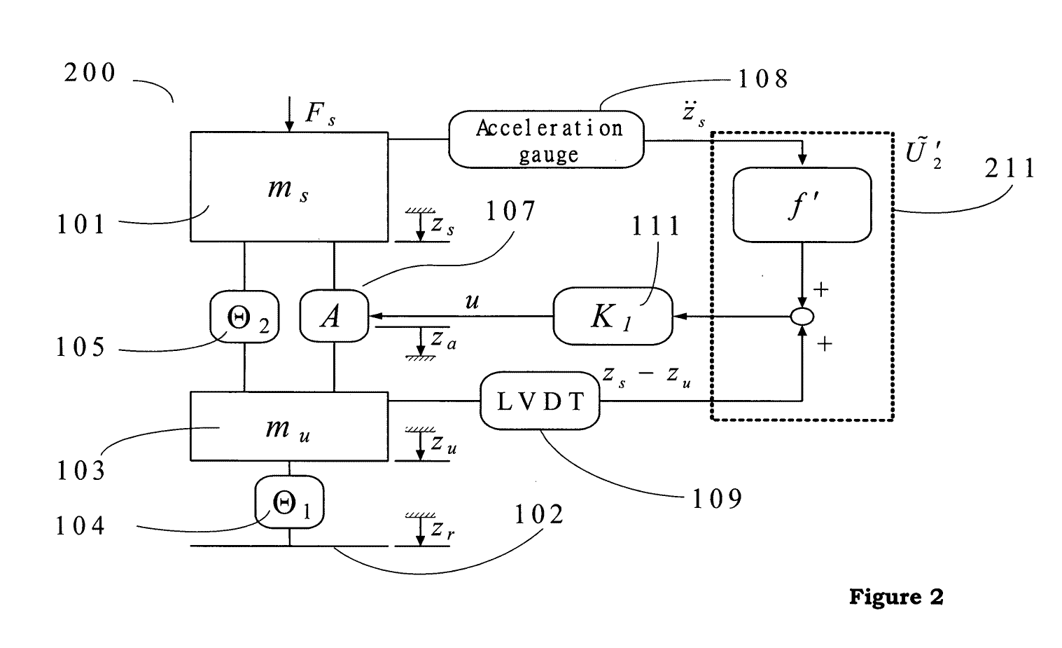

As shown in FIG. 2, another embodiment 200 of this invention with Θ₃=0 is illustrated. When the third passive vibration control component 106 is removed, the output of the active actuator 107 becomes the “applied force”. Similarly, in order to achieve the disturbance response decoupling effect, it is still necessary to install the control loop structure Ũ₂′. Thus, when Θ₃=0 is substituted into the control loop Ũ₂ of the aforementioned optical table 100, it would be able to obtain the control loop Ũ₂′=[mₛ/Θ₂1] of the embodiment.

As shown in FIG. 1, two main external disturbances, Fₛ and zᵣ, are used to illustrate the disturbance response decoupling. When the ground disturbance zᵣ is present, the energy of ground disturbances will be reduced by the first vibration control components 104, the second passive vibration control component 105, and the third passive vibration control component 106. And the control signal u of the active actuator 107 will not be activated, i.e. u=0. When the load disturbance Fₛ, is applied, the control signal u≠0. Thus, the active actuator 107 and the controller 111 can be used to control the load disturbances. When both load disturbance Fₛ and ground disturbance zᵣ are present at the same time, the disturbance response decoupling control loop will produce the corresponding control signal u to suppress the load disturbance Fₛ. In addition, the commercial vibration control platform Newport I-2000 LabLegs™ is used for the first passive vibration control component 104.

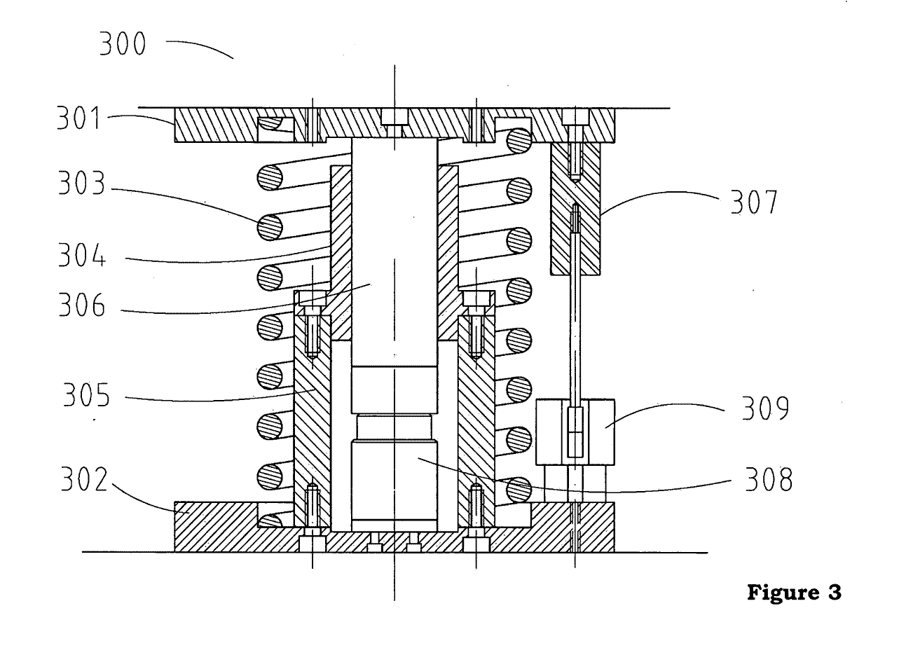

As the drawing 300 shown in FIG. 3, the cross-section of the active actuator 107 is illustrated. It can react with the load disturbance to achieve the disturbance response decoupling effects. In the drawing 300 shown in FIG. 3, there are upper cover spring mount end 301 and lower cover spring mount end 302, the spring 303 to sustain the static load. After installing the linear bearing holder 304 and the bearing supporter 305 in the middle of the structure, the rod 306 is fixed to the coil of voice-coil motor 308, in order to constrain the motion direction, and to make sure that the voice-coil motor 308 will not be influenced by side forces. The main body 309 of the linear variable differential transformer (LVDT) and the extension rod 307 of the LVDT are added to the structure for measuring the relative displacement.

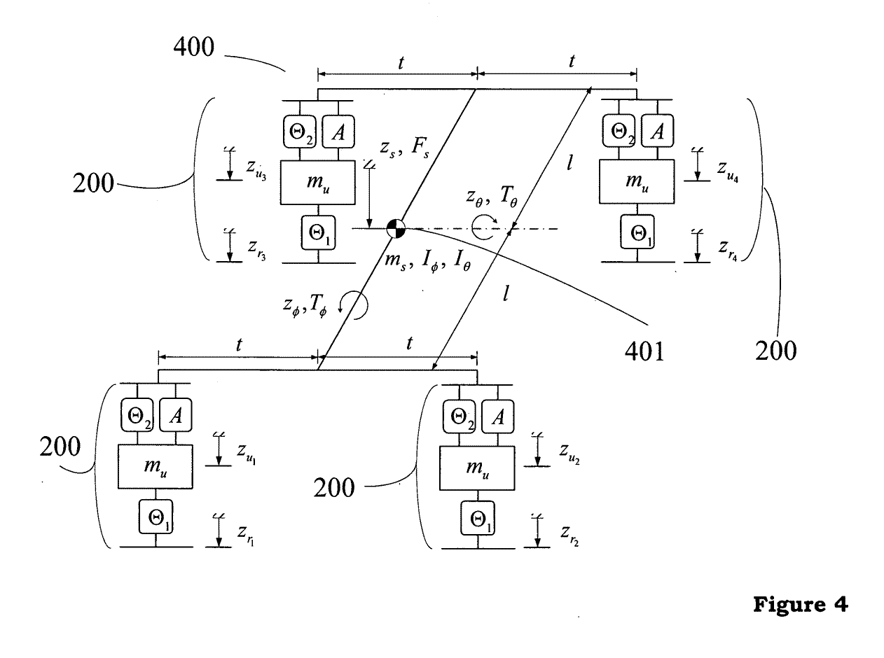

As shown in FIG. 4, the schematic diagram for the vibration control platform of an optical table 400 is illustrated. The vibration control platform of an optical table 400 comprises the embodiment of 4 sets of optical table 200. After a pair (the first pair) of optical table 200 is connected in pair, an optical table board 401 is connected to another pair (the second pair) of optical table 200. The carriage of optical table 200 is to effectively improve the system performance, thus the disturbance response decoupling technology is introduced again to control the whole table platform. Because the whole table platform has 7 degrees of freedom, it is converted to four mutual modes, including-bounce, pitch, roll, and warp through the symmetrical transformation and simplicity transformation. The aforementioned modes can be regarded as the application of individual double-layer platform vibration control apparatus 200.

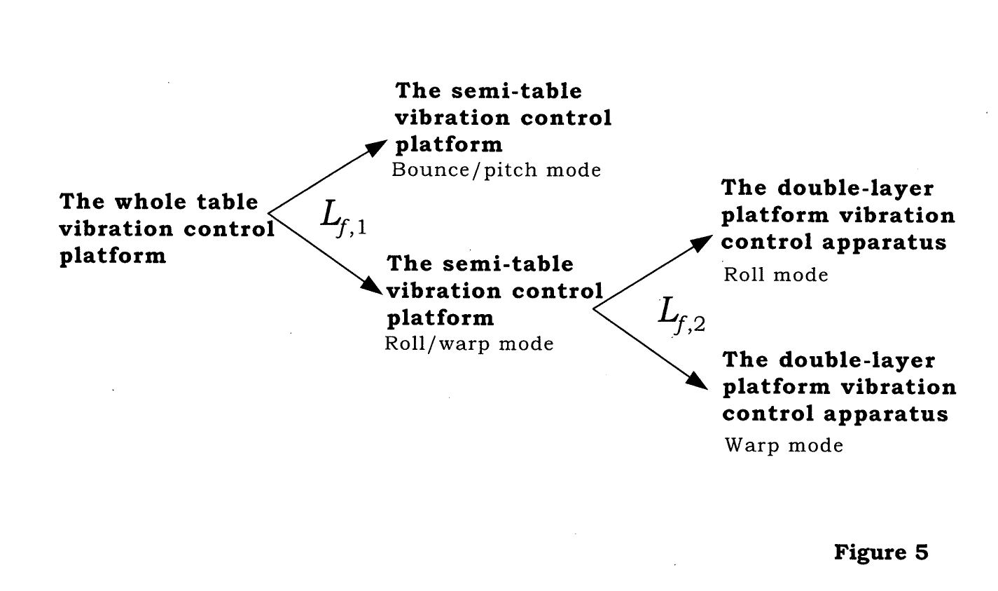

FIG. 5 shows the simplification process for basic principles of vibration control of the optical table.

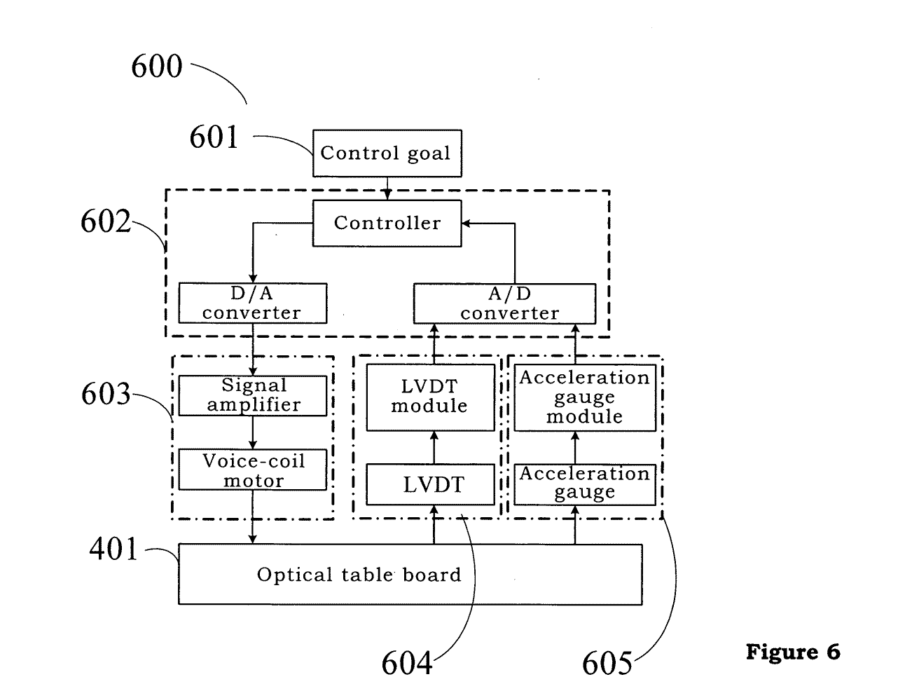

As shown in FIG. 6, the schematic diagram for the vibration control flowchart of this invention is illustrated. Firstly, the control goal 601 is transformed into the vibration controller. After the optical table 401 receives the external disturbances, the feedback signal is measured by the linear variable differential transformer module 604 installed on the active layer and the acceleration gauge module 605 installed at four corners of the table. The signal treatment terminal 602 converts modes, then applies disturbance response decoupling, and calculate control signals. Then the control signals are transmitted to the actuator 603 installed at each active layer, in order to suppress load disturbances. At the same time, the ground disturbances are still controlled by the passive components.

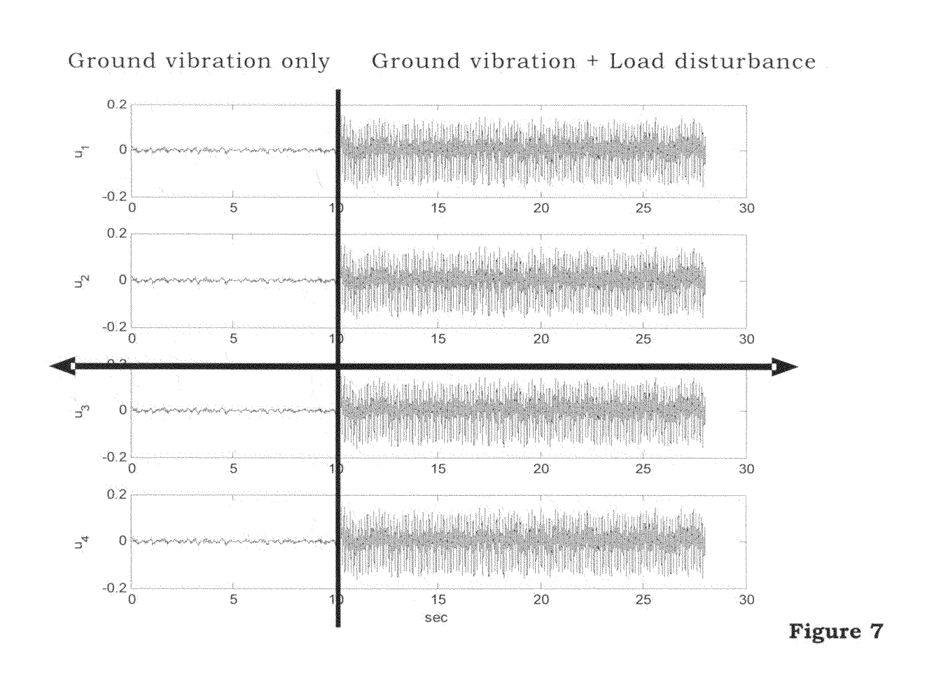

The experimental results for the embodiments of this invention are shown in FIG. 7 to FIG. 10.

FIG. 7 shows the time responses of the system, where the control signal is only excited by the load disturbances.

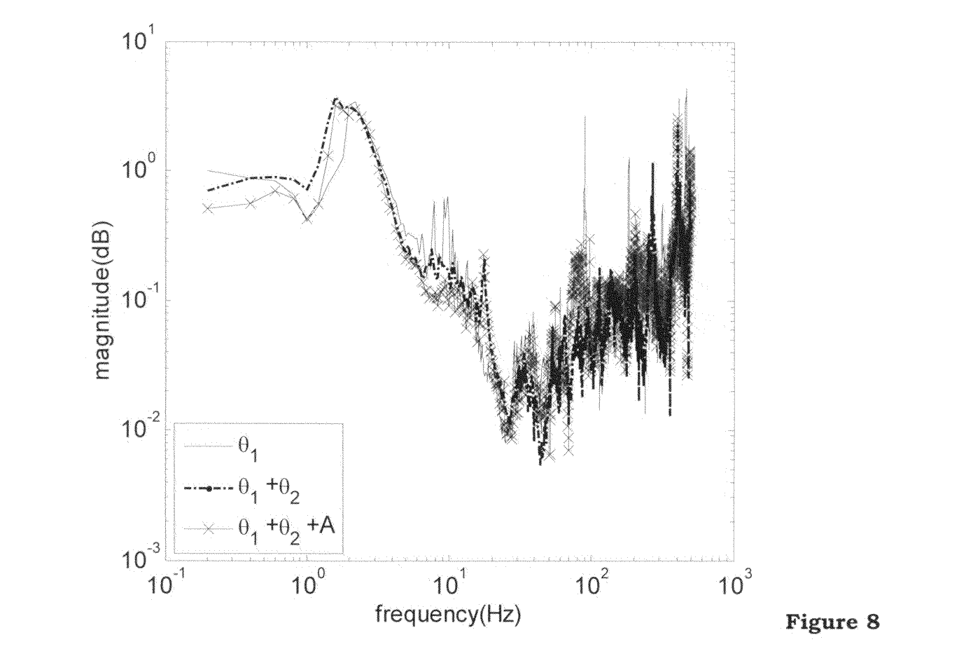

FIG. 8 compares the frequency responses of a conventional vibration control system and the optical table of the invention with or without the active controller. From the results, the active controller will not influence the system performance when there are only ground disturbances.

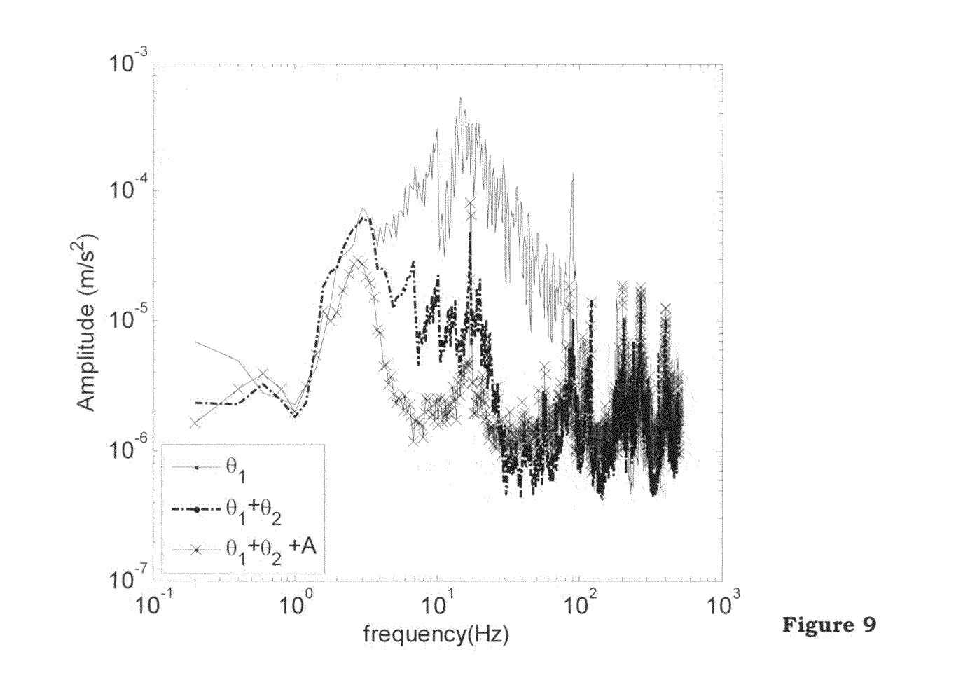

FIG. 9 shows the condition of applying a load disturbance. From the result, the frequency responses can be effectively improved by the active controller.

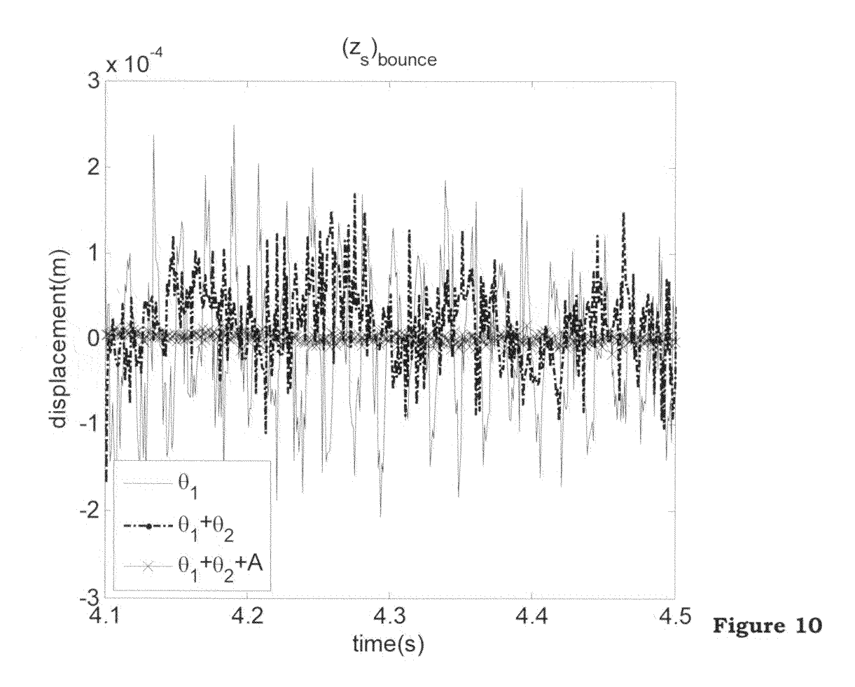

When the load disturbance is applied, the time responses are shown in FIG. 10, where the system performance is greatly improved by the active control.

The optical table provided by this invention connects two vibration control structures, wherein the upper vibration control layout is composed of any type of passive vibration control components (such as springs and dampers) and an active actuator, and the lower vibration control layout is composed of any type of passive vibration control components (such as springs and dampers). By measuring the acceleration of the upper mass and the displacement between the upper mass and the middle mass, the disturbance response decoupling technique is employed to design the feedback control loop, in order to decompose the disturbances for treatment. After designing a suitable controller, the active actuator (such as a voice-coil motor) is employed to generate corresponding mechanical forces, in order to control the load disturbances. Meantime, the ground disturbances can also be controlled by the passive components of the whole double-layer structure.

This invention uses two sets of passive vibration control components. For example, the spring and damper are connected in parallel. And a set of actuator is added in the upper structure, in order to convert the control signal (voltage) into the physical quantity (force) applied at both ends. Therefore, the upper structure can be regarded as the active vibration control layout, and the lower structure can be regarded as the passive vibration control layout. The traditional optical vibration control platform can only control the load or ground disturbances individually. That is, the control of load and ground disturbances is conflicting because of different performance requirements. Thus, the application of disturbance response decoupling to the double-layer structure provided by this invention not only can simplify the vibration control design, but also can improve vibration control performance effectively.

Summarized from the aforementioned description, this invention mainly employs a double-layer vibration control structure and the disturbance response decoupling technique to effectively improve the vibration control of the system. It is characterized by treating the load and ground disturbances separately without influencing each other. This invention uses passive components to control ground disturbances, and uses the active control to improve the responses of load disturbances. The same principle can also be applied to another kind of optical table, which uses the passive components to control load disturbances, and the active control to improve the responses of ground disturbances.

It is understood that various other modifications will be apparent to and can be readily made by those skilled in the art without departing from the scope and spirit of this invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled in the art to which this invention pertains.

What is claimed is:

1. An optical table apparatus, comprising:
an upper mass;
a middle mass;
a lower floor terminal;
a vibration control mechanism, comprising:
a first passive vibration control component;
a second passive vibration control component;
a third passive vibration control component; and
an active actuator having disturbance decoupling function;
a sensor, comprising:
an acceleration gauge; and
a linear variable differential transformer;
a decoupling control loop structure; and
a controller; wherein the upper mass connecting the vibration control mechanism, and connecting the middle mass, and connecting the lower floor terminal, the acceleration gauge connecting the upper mass and the decoupling control loop structure, the controller connecting the active actuator and the decoupling control loop structure, the linear variable differential transformer connecting the middle mass and the decoupling control loop structure, in order to form the optical table apparatus.

2. The apparatus according to claim 1, wherein the upper mass comprises a table board.

3. The apparatus according to claim 1, wherein the middle mass comprises a metal block.

4. The apparatus according to claim 1, wherein the lower floor terminal comprises a ground terminal.

5. The apparatus according to claim 1, wherein the first passive vibration control component comprises a pneumatic vibration control mechanism.

6. The apparatus according to claim 1, wherein the second passive vibration control component comprises a damper.

7. The apparatus according to claim 1, wherein the third passive vibration control component comprises a spring.

8. The apparatus according to claim 1, wherein the active actuator comprises a voice-coil motor.

9. The apparatus according to claim 1, wherein the active actuator comprises a piezoelectric actuator.

10. An optical table apparatus, comprising:
an upper mass;
a middle mass;
a lower floor terminal;
a vibration control mechanism, comprising:
a first passive vibration control component;
a second passive vibration control component; and
an active actuator disturbance decoupling function;
a sensor, comprising:
an acceleration gauge; and
a linear variable differential transformer;
a decoupling control loop structure; and
a controller; wherein the upper mass connecting the vibration control mechanism, and connecting the middle mass, and connecting the lower floor terminal, the acceleration gauge connecting the upper mass and the decoupling control loop structure, the controller connecting the active actuator and the decoupling control loop structure, the linear variable differential transformer connecting the middle mass and the decoupling control loop structure, in order to form the optical table apparatus.

11. The apparatus according to claim 10, wherein the upper mass comprises a table board.

12. The apparatus according to claim 10, wherein the middle mass comprises a metal block.

13. The apparatus according to claim 10, wherein the lower floor terminal comprises a ground terminal.

14. The apparatus according to claim 10, wherein the first passive vibration control component comprises a pneumatic vibration control mechanism.

15. The apparatus according to claim 10, wherein the second passive vibration control component comprises a damper.

16. The apparatus according to claim 10, wherein the third passive vibration control component comprises a spring.

17. The apparatus according to claim 10, wherein the active actuator comprises a voice-coil motor.

18. An optical table vibration control platform, comprising:
a first pair of optical table apparatus;
a second pair of optical table apparatus; and
an optical table board; wherein the first pair of optical table apparatus being connected to the second pair of optical table apparatus through the optical table board, in order to form the optical table vibration control platform.

19. A vibration control method of the a optical table apparatus, comprising:
converting a control goal into a vibration controller;
using an optical table board to receive an external disturbance;
using a linear variable differential transformer module and an acceleration gauge module to measure a feedback signal;
treating the feedback signal by a signal treatment terminal to form a control signal;
sending the control signal to an actuator, in order to form the vibration control method of the optical table.

20. The method according to claim 19, wherein the treatment of feedback signal by signal treatment terminal, comprising:
decoupling a mode;
decoupling disturbance response; and
calculating a control signal.
